(19) United States
(12) Patent Application Publication
(10) Pub. No.: US 2010/0007159 A1
(43) Pub. Date: Jan. 14, 2010

(54) LIFTING HOOK WITH CHAIN LENGTH REDUCER

(75) Inventor: Blaise Henrion, Saint-Avertin (FR)

Correspondence Address: YOUNG & THOMPSON, 209 Madison Street, Suite 500, Alexandria, VA, 22314, US

(73) Assignee: FORGES DE L'EMINEE, S.A.S., Celles sur Durolle (FR)

(21) Appl. No.: 12/281,930

(22) PCT Filed: Mar. 2, 2007
(86) PCT No.: PCT/FR07/00377

§ 371 Date: Jun. 24, 2009

(30) Foreign Application Priority Data
Mar. 6, 2006 (FR) 0602048

(51) Int. Cl. B66C 1/36; B66C 1/34

(52) U.S. Cl. 294/82.2

(57) ABSTRACT

A lifting hook that can be used to lift loads using lifting gear includes a hook-shaped part which hooks onto the load to be lifted and a chain length reducer secured to the hook. The reducer includes an orifice whose dimensions allow the links of the chain to pass through and then allow one of the links to be locked in position when the chain is taut, and elements for partially closing off the orifice which are hinged so that they can be released manually simply by pressing them so as to allow the length of the chain to be adjusted. The reducer includes a closure finger that closes off the hook-shaped part and the closing-off elements include self-locking members which hold the closure finger in the locked position on the part of the hook as long as the closing-off elements are disengaged from the orifice.

This invention relates to a load lifting hook that can be used in particular to lift loads such as large metallic parts, engines, machines, etc.

Lifting hooks are commonly used to lift parts having a large mass reaching several hundred kilograms, and even several tonnes. These parts are generally moved using a bridge crane that comprises a lifting gear comprised of a traction chain and a motor winch making it possible to raise and lower the chain in order to lift the part, and to be able to move it. The chain is coupled with the hook that hooks for example onto a lifting ring attached to the part, making it possible to grasp it.

It is known to use chain length reducing devices to best stretch the latter before subjecting it to a pulling force by lifting the load. As such, brutal impacts are avoided on the hook, chain and motor winch, caused by the winding speed of the chain on the drum of the winch which is carried out empty then, suddenly, under the weight of the part. These reducers also make it possible to take up the slack in the chains which are attached to a part using several hooks hooked at various heights and positions on said part. The taking up the slack thus makes it possible to balance the load as soon as it is lifted, which makes it possible to maintain it in a stable position.

Those skilled in the art can refer to the following prior patents that refer to chain length reducers: WO 0221014; GB 2088520; GB 2127129; WO 9723406; JP 1236195; WO 04087553; WO 04087554; DE 20205316U.

The reducer can either be as a direct link with the hook, by means of a hinge, or be as an indirect link with the hook, positioned in the vicinity of the latter on the chain. It is comprised of a planar or curved part with a concavity, said part having an orifice of which the approximate shape is that of a planar or curved cross in the concave portion. The dimensions of the orifice allow the links of the chain to pass through in order to translate it and adjust its length, and then the locking of one or several of said links on the upper edge and/or on the lower edge of the cross-shaped orifice, bearing against the planar or concave shape of the part, when said chain is subjected to a traction by lifting the object.

One of the disadvantages of reducers is that there subsists, subsequent to the adjustment of the length of the chain by means of said reducer, a slight slack on the chain engaged in the reducer, as long as the latter is not fully taut under the action of the load. The links of the chain can then move in the cross-shaped orifice of the reducer and become incorrectly positioned, which could result in the translation of several links of the chain through the orifice before its locking in the reducer when the motor winch is actuated, and for example cause a change in the length of the chain and therefore an imbalance of the load when it is lifted.

For this, certain reducers, such as those described in patents WO 0221014, GB 2088520 and GB 2127129 provide closing-off means of the orifice comprised of a transversal axis which slides and partially closes off the interior of the cross-shaped orifice in order to prevent displacement of the link of the chain positioned in said orifice, and as such prevent the latter from becoming disengaged and translate through the reducer, which makes it possible to preserve the length of the chain such as it is adjusted. The disadvantage with this axis is that it is difficult to manipulate it when setting it into position or when removing it. Indeed, the user, who manipulates the hook or the reducer in order to adjust the length of the chain or remove the latter, must simultaneously hold the hook or the reducer, slide the axis in order to clear the partially closed-off orifice and adjust the chain; said axis being generally spring-mounted in order to guarantee the permanent closing off of the orifice as soon as it ceases being manipulated. In addition, the user is obliged to manipulate the hook with protective gloves in order to comply with safety requirements, which reduces the manoeuvrability of the reducer and of the axis when the length of the chain is being adjusted.

Likewise, another reducer, such as that described in the German utility model DE 20205316, proposes to close off the orifice and consequently prevent the removal of the link of the chain from the locking slot located above the orifice. This closing off is obtained via a pivoting finger, provided with a return spring which constantly provides said closing off. The user must, in order to adjust the length of the chain or remove it, simultaneously act on the chain and hold the finger in open position. However, taking into account the position and the dimensions of the pivoting finger, the mandatory use of protective gloves makes this manipulation delicate.

The purpose of this invention is to overcome this disadvantage by proposing a hook provided with a chain length reducer which has means of closing-off the cross-shaped orifice, that can be manipulated easily by the simple grasping of the hook in order to allow for very easy manual adjustment and preserve this adjustment as long as the chain is not fully taut, i.e. as long as the chain is not lifting the load.

It also has for purpose to guarantee a perfect positioning of the links of the chain in the cross-shaped orifice during the hooking of the hook onto the load.

To that effect, the invention relates to a lifting hook, which can be used to lift loads using a lifting gear, comprising a hook-shaped part that hooks onto the load to be lifted and a chain length reducer, said reducer being secured to the upper end of the hook and coupling with a chain by locking of one of its links in the reducer, said reducer comprising on the one hand a concavity and an orifice of which the dimensions make it possible for the links of the chain to pass through said orifice, then the locking of one of said links positioned against the upper edge of the orifice, in the concavity, when said chain is taut, and on the other hand means for partially closing-off and an external face, said closing-off means being located against the face, said closing-off means being hinged to be released manually simply by pressing them so as to allow the length of the chain to be adjusted, notable in that the reducer comprises a closure finger that closes off the hook-shaped part to prevent the load from becoming unhooked, and in that the closing-off means comprise self-locking means which hold the closure finger in locked position on the portion of the hook as long as the closing-off means are disengaged from the orifice and have not yet been returned to a position in which they bear against the external face.

Other advantages and characteristics of this invention shall become more obvious in the description hereinbelow which is provided by way of a non-limiting example, in reference to the drawings among which:

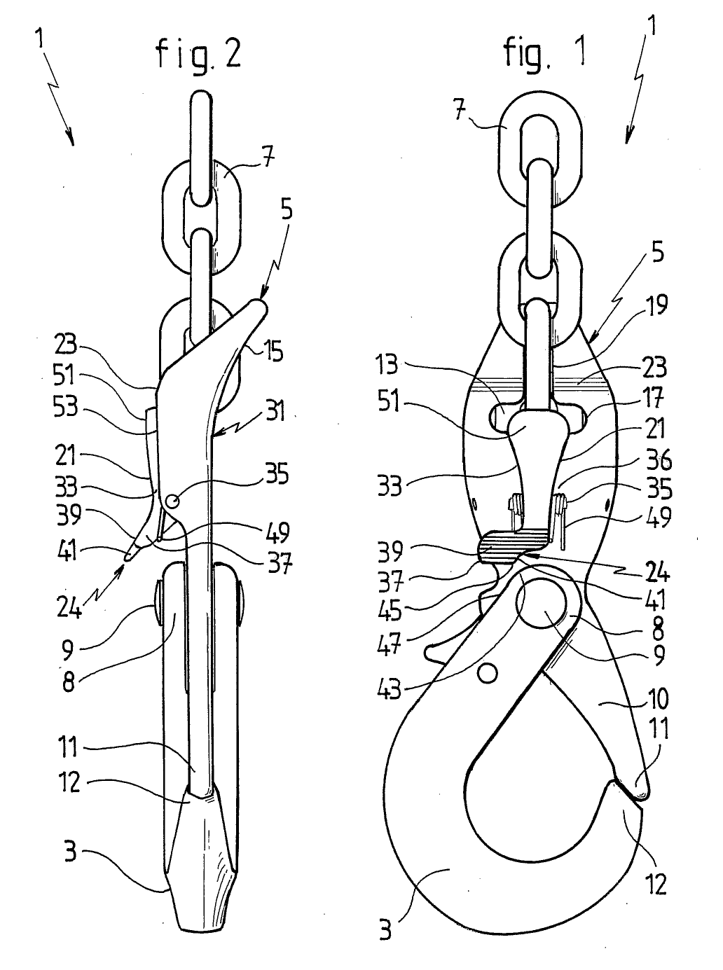

FIG. 1 shows a front view of the lifting hook according to the invention,

FIG. 2 shows a side view of the lifting hook according to the invention,

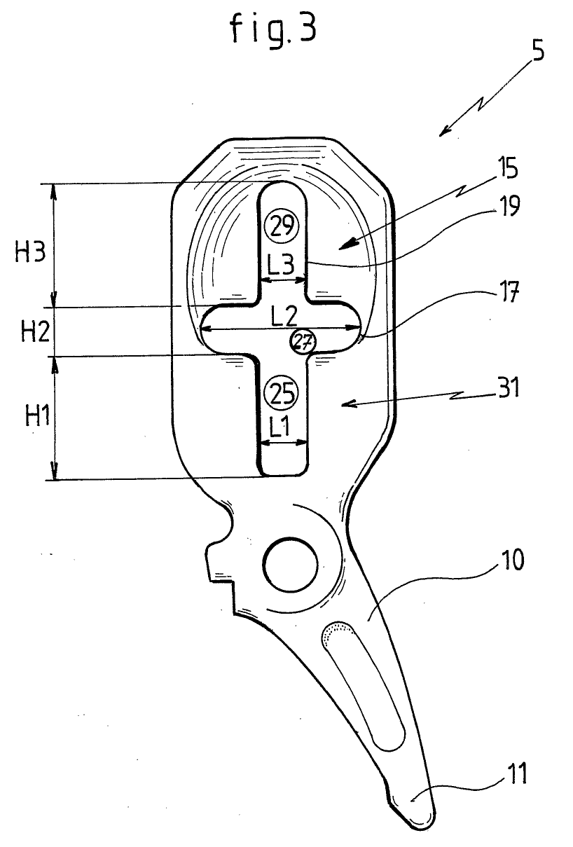

FIG. 3 shows a view of the reducer.

The lifting hook 1, according to the invention, can be used in particular to lift and move loads using a lifting gear such as a bridge crane. It is comprised, according to a preferred and non-limiting embodiment shown in FIGS. 1 and 2, of a hook-shaped part 3 which is intended to hook onto the load, either directly or by using an intermediate lifting ring attached to the load to be lifted (not shown in the figures).

The hook 1 comprises an adjustable chain 7 length reducer 5, hinged at the upper end 8 of the hook-shaped part 3 and coupling with a traction chain 7 which is for example wrapped around a motor winch drum (not shown). According to a preferred embodiment, the reducer 5 is directly hinged on the upper end 8 using a pivot link 9.

The reducer 5 comprises a closure finger 10 of the hook-shaped part 3. The finger 10 extends to the bottom end of the reducer 5, below the pivot link 9, and to its end 11 which bears against the end 12 of the hook-shaped part 3, in order to close the latter and prevent the load from becoming unhooked that is assembled with the hook.

The reducer 5 makes it possible to adjust the length of the chain 7 to stretch it to the maximum before lifting the load. Such as shown in FIG. 1, the chain 7 is coupled with the reducer 5 by locking of one 13 of its links in said reducer 5, when the chain 7 is taut. The reducer 5 comprises, according to a preferred embodiment shown in the figures, a concavity 15 comprising an orifice 17 of which the dimensions allow for the passing of the links of the chain 7 through the latter, then the locking of one 13 of said links positioned against the upper edge 19 of the orifice 17, located in the concavity 15, once the length of the chain 7 is adjusted to its maximum, i.e. almost taut and on the point of lifting the load.

According to the invention, the reducer comprises means of partially closing off 21 the orifice 17. These means of partially closing-off 21 are notably arranged on the external face 23 of the reducer 5 and against the latter. They are hinged on the external face 23 of the reducer 5 and can be disengaged manually via a simple press, for example with the thumb or index finger of the hand which grasps and holds the hook 1 or the reducer 5, which thus makes it possible to release the orifice 17 and to adjust the length of the chain 7.

The hook 1 according to the invention is notable in that the closing-off means 21 comprise self-locking means 24. The self-locking means 24 are positioned on the upper end 8 of the part 3 of the hook and come to bear against the latter when the closing-off means 21 are disengaged from the external face 23 of the reducer 5, thus blocking the pivot link 9, which prevents the rotation of the finger 10 in relation to the part 3 and therefore prevents the opening of the finger 10 to hook the load onto said part 3. These self-locking means 24 hold the finger 10 in locked position on the part 3 of the hook as long as the closing-off means 21 are disengaged from the orifice 17 and have not yet been returned to a position in which they bear against the external face 23. This design has the substantial advantage of obliging the user to correctly position the links of the chain 7 in the orifice 17 of the reducer 5 and to correctly position the closing-off means 21 against the external face 23, before being able to open the hook in order to assemble it with the load.

Such as shown in FIG. 3, the reducer 5 comprises an orifice 17 of which the shape is, more preferably, that of a cross. The cross has a bottom end 25 of width L1 and of height H1, a central portion 27 of width L2 and of height H2, a top end 29 of width L3 and of height H3. The dimensions of L1, H1, L2, H2, L3 and H3 are chosen according to the size of the links of the chain 7 and allow said links to pass through the orifice 17 when the latter is fully open. According to a preferred embodiment, the bottom end 25 and possibly the central portion 27 are closed by the closing-off means 21 when the latter are bearing against the external face 23 of the reducer.

The reducer 5 is arched on its upper portion and flat on its lower portion. As such, the external face 23 of the reducer 5 is planar on its lower portion which comprises, according to a preferred embodiment, at least the bottom end 25 and the central portion 27 of the cross-shaped orifice. The internal face 31, opposite the external face 23, comprises the concavity 15 on its upper portion, said concavity 15 comprising the top end 29 of the cross-shaped orifice 17.

According to a preferred and non-limiting embodiment, shown in FIGS. 1 and 2, the means for partially closing-off 21 are comprised of a closure flap 33. The flap 33 bears against the bottom portion of the external face 23 which is planar, which makes it possible to close the orifice 17 on its bottom end 25 and on its central portion 27, as such suppressing the movements of the link 13 in position in the top end 29 of the orifice 17, located in the concavity 15.

The closure flap 33 is hinged on the external face 23 of the reducer 5. This hinge is implemented using a pivot link 35 arranged on the external face 23. For this, the bottom portion on the external face 23 comprises a cavity 36 wherein is implemented said pivot link 35 and wherein the flap 33 is housed.

The flap is notable in that it comprises a manipulation finger 37 arranged on its lower portion located below the axis of the pivot link 35, which makes it possible to pivot said flap 33, by pressing on the finger 37, to open it and disengage the orifice 17 in order to adjust the length of the chain. The finger 37 comprises, more preferably, ridges 39 on its upper face, which can be grasped easily by the finger of the hand of the user, and particularly by a glove.

According to a preferred embodiment of the hook 1 according to the invention, the finger 37 of the flap 33 comprises the self-locking means 24. For this, the self-locking means 24 are comprised of an unhooking 41 arranged at the end of the finger 37. The unhooking 41 is more preferably of a shape corresponding to that of the upper end 8 of the part 3 in the shape of a hook. As such, the unhooking 41 is for example of rounded shape similar to the rounded form 43 of the upper end 8 of the part 3. The unhooking 41 of the finger 37 hugs the upper end 8 and therefore has its end 45 which is bearing against the face 47 of said upper end 8. The end 45 is held against the face 47 as long as the flap 33 is disengaged from the orifice 17 and has not yet been returned to a position in which it bears against the external face 23 of the reducer 5.

The flap comprises a return spring 49 which makes it possible to hold through a press the upper portion 51 of said flap 33 on the bottom end 25 and the central portion 27 of the orifice 17, in order to permanently close off said orifice 17. The spring 49 is more preferably a spiral spring positioned on the axis of the pivot link 35, in the cavity 36 on the external face 23. As such, when the user presses on the finger 37, the spring is compressed and the flap opens to release the orifice and adjust the chain, then it closes up again systematically under the action of the spring 49 when the user releases the finger 37.

The spring constant of the return spring 49 is chosen in order to provide for maintaining the flap 33 closed on the orifice 17 when the chain 7 is not taut and that the links, in position in the reducer 5, exert a pressing on the internal face 53 of the flap 33.

As such the flap 23 opens very easily by grasping the hook 1, the grasping of said hook making it possible to systematically press on the finger 37. The hook is manufactured in the metallurgical industry. Its dimensions are adapted to the load to be lifted and to the dimensions of the links of the chain.

Other embodiments of the lifting hook can be considered by those skilled in the art without leaving the framework of this invention.

1. Lifting hook (1), which can be used to lift loads using a lifting gear, comprising a hook-shaped part (3) that hooks onto the load to be lifted and a chain length reducer (5), said reducer (5) being secured to the upper end (9) of the hook and coupling with a chain (7) by locking of one (13) of its links in the reducer (5), said reducer (5) comprising on the one hand a concavity (15) and an orifice (17) of which the dimensions allow for the passing of the links of the chain (7) through said orifice (17), then the locking of one (13) of said links positioned against the upper edge (19) of the orifice (17), in the concavity (15), when said chain (3) is taut, and on the other hand means for partially closing-off (21) of the orifice (17) and an external face (23), said closing-off means (21) being located against the face (23), said closing-off means (21) being hinged to be released manually simply by pressing them so as to allow the length of the chain (7) to be adjusted, characterised in that the reducer (5) comprises a closure finger (10) of the part (3) in the shape of a hook to prevent the load from becoming unhooked, and in that the closing-off means (21) comprise self-locking means (24) which hold the closure finger (10) in locked position on the part (3) of the hook as long as the closing-off means (21) are disengaged from the orifice (17) and have not yet been returned to a position in which they bear against the external face (23).

2. Lifting hook (1), as claimed in claim 1, characterised in that the orifice (17) is in the shape of a cross which has a bottom end (25), a central portion (27) and a top end (29), and in that the bottom portion of the external face (23) of the reducer (5) is planar and comprises at least the bottom end (25) and the central portion (27) of the cross-shaped orifice (17), which are closed by the closing-off means (21).

3. Lifting hook (1), as claimed in claim 1, characterised in that the means for partially closing-off (21) are comprised of a closure flap (33) which bears against the external face (23) of the reducer (5) and partially closes the orifice (17).

4. Lifting hook (1), as claimed in claim 3, characterised in that the closure flap (33) is hinged as a pivot link (35) on the reducer (5).

5. Lifting hook (1), as claimed in claim 3, characterised in that the flap (33) comprises a finger (37) making it possible to pivot said flap (33) in order to open it and disengage the orifice (17).

6. Lifting hook (1) as claimed in claim 5, characterised in that the finger (37) comprises the self-locking means (24), said self-locking means (24) being comprised of an unhooking of a shape corresponding to that of the upper end of the hook-shaped part (3).

7. Lifting hook (1) as claimed in claim 6, characterised in that the unhooking of the finger hugs the upper end of the portion (3) and holds it against therein as long as the flap (33) is disengaged from the orifice (17).

8. Lifting hook (1), as claimed in claim 3, characterised in that the flap (33) comprises a return spring (49) which holds said flap (33) under pressure on the orifice (17) and permanently closes off the latter.
